(19) United States
(12) Patent Application Publication
(10) Pub. No.: US 2024/0220808 A1
(43) Pub. Date: Jul. 4, 2024

(54) ANOMALY DETECTION METHOD AND DEVICE THEREFOR

(71) Applicant: NEUROCLE INC., Seoul (KR)

(72) Inventor: Gwang Min KIM, Seoul (KR)

(21) Appl. No.: 18/026,064

(22) PCT Filed: Jul. 5, 2021
(86) PCT No.: PCT/KR2021/008516

§ 371 Date: Mar. 13, 2023

(30) Foreign Application Priority Data
Sep. 11, 2020 (KR) 10-2020-0116988

(51) Int. Cl. G06N 3/088

(52) U.S. Cl. CPC G06N 3/088

(57) ABSTRACT

Provided is an anomaly detection method and device, and the anomaly detection method may include: allowing a network function to learn mapping of first embedded features corresponding to learning data onto an embedding space, the learning data having at least one or more normal data; inputting input data to the network function subjected to the embedding learning to thus map second embedded features corresponding to the input data onto the embedding space; calculating anomaly scores based on the distances between the second embedded features and at least one or more first embedded features proximal to the second embedded features; and determining whether the input data are normal, based on the calculated anomaly scores.

### TECHNICAL FIELD

The present disclosure relates to an anomaly detection method and device, and more specifically, to an anomaly detection method and device using auxiliary data.

### BACKGROUND ART

Machine learning is a branch of artificial intelligence, which develops algorithms and technologies capable of giving computers the capability to learn, based on data, so that it has provided excellent performance on prediction and anomaly detection as major techniques in various fields of image processing, image recognition, voice recognition, internet search, etc.

Anomaly detection is the process of identifying objects or data having unexpected patterns in a set of data, and a conventional machine learning-based anomaly detection model calculates a difference between real data and expected data and determines that the real data are abnormal if the difference is greater than a threshold value.

Conventional machine learning-based anomaly detection methods have been disclosed, but in the case of existing supervised learning-based anomaly detection models, it is not easy to perform labeling for data one by one upon collection of the data.

In learning abnormal data with extremely small amounts, further, it is difficult to enhance distinguishing performance only with the extremely small amounts of data, thereby failing to perform such training capable of distinguishing normal data and abnormal data.

### DISCLOSURE OF THE INVENTION

### Technical Problems

Accordingly, it is an object of the present disclosure to provide an anomaly detection method and device that is capable of performing learning with normal data and abnormal data together to thus enhance anomaly detection performance.

The technical problems to be achieved through the present disclosure are not limited as mentioned above, and other technical problems not mentioned herein will be obviously understood by one of ordinary skill in the art through the following description.

### Technical Solutions

To accomplish the above-mentioned objects, according to one aspect of the present disclosure, an anomaly detection method may include the steps of: allowing a network function to learn mapping of first embedded features corresponding to learning data onto an embedding space, the learning data having at least one or more normal data; inputting input data to the network function subjected to the embedding learning to thus map second embedded features corresponding to the input data onto the embedding space; calculating anomaly scores based on the distances between the second embedded features and at least one or more first embedded features proximal to the second embedded features; and determining whether the input data are normal, based on the calculated anomaly scores.

According to an exemplary embodiment of the present invention, the learning data may further include at least one or more auxiliary data, and the auxiliary data may have classes not overlap with the normal data.

According to an exemplary embodiment of the present invention, the learning of the network function may be performed to map the first embedded features produced from the learning data having the same class as one another onto positions proximal to one another and map the first embedded features produced from the learning data having different classes from one another onto positions distant from one another.

According to an exemplary embodiment of the present invention, the network function may perform the learning based on at least one or more loss functions selected from Triplet loss, Max margin, NT-Xent, and NT-Logistic.

According to an exemplary embodiment of the present invention, the step of calculating anomaly scores may include the steps of: detecting at least one or more first embedded features in order of proximity to the second embedded features; and calculating the sum or average of distances between the second embedded features and the detected first embedded features.

According to an exemplary embodiment of the present invention, the step of calculating anomaly scores may calculate the anomaly scores based on a K-Nearest Neighbor (KNN) function.

To accomplish the above-mentioned objects, according to another aspect of the present disclosure, an anomaly detection device may include: a memory for storing a program for anomaly detection; and a processor for executing the program to allow a network function to learn mapping of first embedded features corresponding to learning data onto an embedding space, input given input data to the network function subjected to the embedding learning to thus map second embedded features corresponding to the input data onto the embedding space, calculate anomaly scores based on the distances between the second embedded features and at least one or more first embedded features proximal to the second embedded features, and determine whether the input data are normal, based on the calculated anomaly scores, wherein the learning data have at least one or more normal data.

According to an exemplary embodiment of the present invention, the learning data may further include at least one or more auxiliary data, and the auxiliary data have classes not overlap with the normal data.

According to an exemplary embodiment of the present invention, at the step of learning, the network function may learn to map the first embedded features produced from the learning data having the same class as one another onto positions proximal to one another and map the first embedded features produced from the learning data having different classes from one another onto positions distant from one another.

According to an exemplary embodiment of the present invention, at the step of learning, the network function may perform the learning based on at least one or more loss functions selected from Triplet loss, Max margin, NT-Xent, and NT-Logistic.

According to an exemplary embodiment of the present invention, the processor may detect at least one or more first embedded features in order of proximity to the second embedded features and calculate the anomaly scores based on the sum or average of distances between the second embedded features and the detected first embedded features.

According to an exemplary embodiment of the present invention, the processor may calculate the anomaly scores based on a K-Nearest Neighbor (KNN) function.

### Advantageous Effectiveness

According to the embodiments of the present disclosure, the anomaly detection method and device can detect whether the input data are normal accurately, based on the distances between the learning data (that is, the normal data) and the input data in the embedding space.

According to the embodiments of the present disclosure, further, the anomaly detection method and device can perform the embedding learning with a lot of auxiliary data as well as the normal data, so that the distinguishable features from the auxiliary data can be also learned, and the feature extractor with a better quality than that only with normal data learning can be learned, thereby improving accuracy and efficiency in the anomaly detection.

The effectiveness of the present disclosure is not limited as mentioned above, and it should be understood to those skilled in the art that the effectiveness of the present disclosure may include another effectiveness as not mentioned above from the detailed description of the present invention.

### BRIEF DESCRIPTION OF DRAWINGS

A brief description of the drawings is given to allow the drawings suggested in the present disclosure to be more clearly understood.

FIG. 1 is a flowchart showing an anomaly detection method according to an embodiment of the present disclosure.

FIG. 2 shows examples of learning data in the anomaly detection method according to the embodiment of the present disclosure.

FIGS. 3 and 4 show exemplary learning processes of a network function through the learning data in the anomaly detection method according to the embodiment of the present disclosure.

FIGS. 5 and 6 show exemplary processes of distinguishing normal data and abnormal data in the anomaly detection method according to the embodiment of the present disclosure.

FIG. 7 shows the auxiliary data utilization effectiveness in the anomaly detection method according to the embodiment of the present disclosure.

FIG. 8 is a schematic block diagram showing a configuration of an anomaly detection device according to another embodiment of the present disclosure.

### MODE FOR INVENTION

The present disclosure may be modified in various ways and may have several exemplary embodiments, and specific exemplary embodiments of the present disclosure are illustrated in the drawings and described in detail in the detailed description. However, this does not limit the present disclosure within specific embodiments and it should be understood that the present disclosure covers all the modifications, equivalents, and replacements within the idea and technical scope of the invention.

If it is determined that the detailed explanation on the well known technology related to the present disclosure makes the scope of the present disclosure not clear, the explanation will be avoided for the brevity of the description. Terms (for example, the first, the second, etc.) may be used just as identification terms for distinguishing one element from the other element.

In the present disclosure, when it is said that one element is described as being “connected” or “coupled” to the other element, one element may be directly connected or coupled to the other element, but it should be understood that another element may be present between the two elements.

The terms “unit”, “-or/er” and “module” described in the present disclosure indicate a unit for processing at least one function or operation, which may be implemented by hardware such as a processor, a micro processor, a micro controller, a central processing unit (CPU), graphics processing unit (GPU), an accelerate processor unit (APU), a digital signal processor (DSP), an application specific integrated circuit (ASIC), a field programmable gate arrays (FPGA), and the like, software, or a combination thereof.

Further, it should be appreciated that the division of the parts in the present disclosure is just made according to principal functions the parts have. That is, two or more parts as will be discussed below may be combined to one part or one part may be divided into two or more parts according to more specified functions. Moreover, the respective parts as will be discussed in the specification can additionally perform some or all of functions performed by other parts as well as their main functions, and of course, also, some of the main functions of the respective parts can be performed only by other parts.

Hereinafter, embodiments of the present disclosure will be described in detail sequentially.

In the specification, a network function may be used with the same meaning as a neural network. In this case, the neural network is composed of interconnected calculation units, which are commonly called nodes, and the nodes are called neurons. Generally, the neural network is made up of a plurality of nodes. The nodes for constituting the neural network are connected to one another by means of one or more links.

Some of nodes constituting the neural network build one layer, based on their distances from an initial input node. For example, a collection of nodes with the distances of n from the initial input node builds an n layer.

The neural network as explained in the specification may include deep neural network (DNN) including a plurality of hidden layers as well as input and output layers.

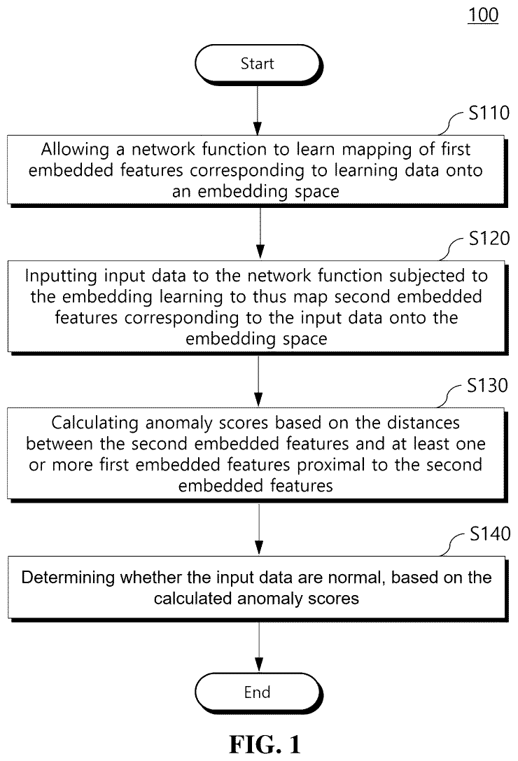

FIG. 1 is a flowchart showing an anomaly detection method according to an embodiment of the present disclosure.

An anomaly detection method 100 according to an embodiment of the present disclosure may be performed by a personal computer, a workstation, a computing device for a server, and the like, which have computational capability, and otherwise, the method may be performed by a device for anomaly detection.

Further, the anomaly detection method 100 may be performed by one or more operation devices. For example, at least one or more steps in the anomaly detection method according to the present disclosure may be performed by a client device, and other steps by a server device. In this case, the client device and the server device are connected to each other by a network and transmit and receive the operation results to and from each other. Otherwise, the anomaly detection method 100 may be performed by distributed computing.

At step S110, the anomaly detection device performs embedding learning using a network function. In this case, an embedding is the process of converting high-dimensional data into a low-dimensional vector, and the network function may be a neural network for converting dimensions of input data to obtain efficient embedded data (that is, low-dimensional vector).

At the step S110, learning of the network function is performed to map first embedding features corresponding to learning data onto an embedding space. If the mapping of the learning data onto the low-dimensional embedding space from the native space thereof is learned, the embedding space is used in determining whether input data are normal, based on the proximity of the embedded features, which will be discussed later.

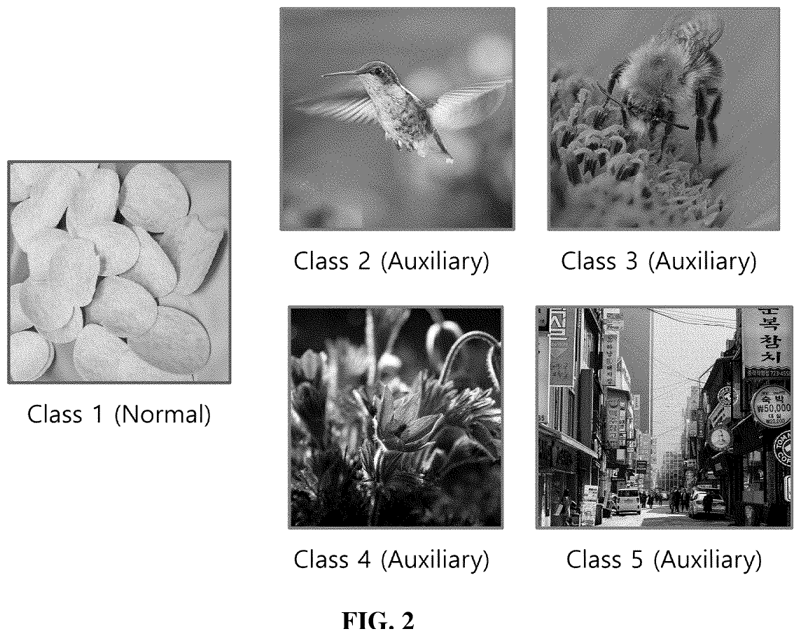

According to the embodiment of the present disclosure, the learning data includes at least one or more normal data and auxiliary data. For example, as shown in FIG. 2, the normal data and auxiliary data are image data, and the auxiliary data have classes not overlap with the normal data.

According to the anomaly detection method of the present disclosure, a lot of auxiliary data are learned together with normal data, and accordingly, features that are distinguished from the auxiliary data are also learned, so that a feature extractor with a better quality than that only with normal data learning can be learned.

At the step S110, the learning of the network function is performed to map the first embedded features produced from the learning data having the same class as one another onto positions proximal to one another and map the first embedded features produced from the learning data having different classes from one another onto positions distant from one another. Accordingly, through the network function, normal data are mapped onto the positions proximal to one another in the embedding space, and auxiliary data with difference classes from the normal data onto the positions distant from one another.

According to the embodiment of the present disclosure, the network function performs the learning based on at least one or more loss functions selected from Triplet loss (e.g., semi-hard triplet loss and/or hard triplet loss), Max margin, NT-Xent, and NT-Logistic.

According to the embodiment of the present disclosure, the anomaly detection method 100 further includes the step of preparing the learning data before the step S110. For example, the anomaly detection device produces the learning data based on at least one or more normal data that are determined as normal data through the network functions and the auxiliary data inputted by a user or pre-stored.

At step S120, the anomaly detection device inputs input data to the network function learned at the step S110 to thus map second embedded features corresponding to the input data onto the embedding space. In the same manner as the first embedded features, the second embedded features are obtained by converting the input data into low-dimensional vectors.

At step S130, the anomaly detection device calculates anomaly scores based on distances between the second embedded features and at least one or more first embedded features proximal to the second embedded features in the embedding space.

According to the embodiment of the present disclosure, the step S130 includes the steps of detecting at least one or more first embedded features in order of proximity to the second embedded features and calculating the sum or average of distances between the second embedded features and the detected first embedded features.

According to the embodiment of the present disclosure, the anomaly detection device calculates the anomaly scores based on a K-Nearest Neighbor (KNN) function. For example, the anomaly detection device detects k (at least one or more) first embedded features in order of proximity to the second embedded features with respect to the positions of the second embedded features in the embedding space through the KNN function and then calculates the anomaly scores based on the sum or average of distances between the second embedded features and the detected k first embedded features.

At step S140, the anomaly detection device determines whether the input data are normal, based on the calculated anomaly scores. That is, the first embedded features corresponding to the normal data included in the learning data are proximal to one another in the embedding space and thus clustered, through the step S110, and based on the distances between the first embedded features and the second embedded features corresponding to the input data, accordingly, if the anomaly scores are greater than a threshold value, it is determined that the input data are abnormal data.

In this case, the threshold value for determining whether the input data are normal or abnormal, based on the calculated anomaly scores, is an optimal threshold detected by the user, and accordingly, the normal data are detected, based on the threshold value. For example, validation data are inputted to the learned network function, and next, the anomaly score having the highest F1 score is set as the threshold value.

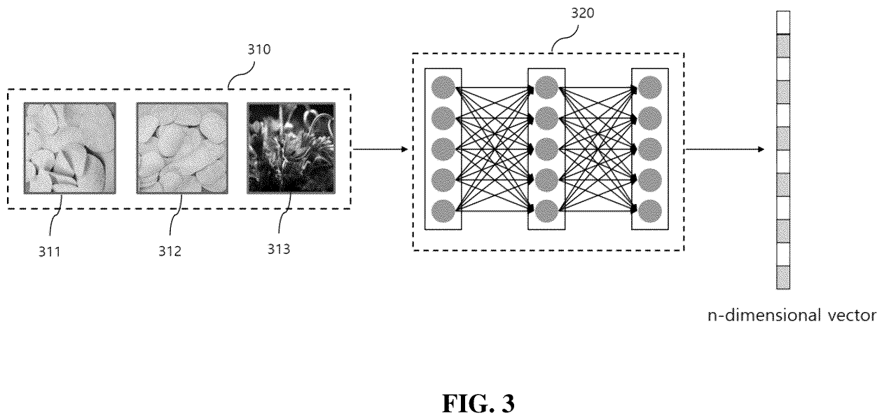

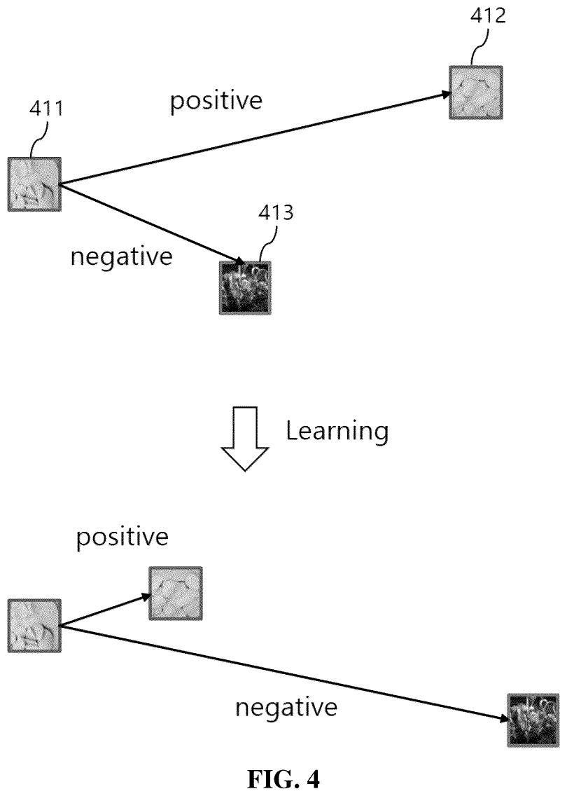

FIGS. 3 and 4 show exemplary learning processes of the network function through the learning data in the anomaly detection method according to the embodiment of the present disclosure.

Referring first to FIG. 3, learning data 310 having a plurality of normal images 311 and 312 and an auxiliary image 313 are inputted to a network function 320, and the network function 320 performs embedding learning with the learning data 310. Through the embedding learning, the first embedded features corresponding to the learning data 310 are outputted, and such first embedded features are made by converting high-dimensional image features into a low-dimensional vector.

Referring to FIG. 4, the embedding learning of the network function is performed, based on loss functions such as Triplet loss and the like. If the learning is performed using the loss functions such as Triplet loss, the relations between positive samples and negative samples in the embedding space are learned. That is, the embedding learning is performed so that the data having the similar features (or the same class) to one another are located proximal to one another in the embedding space and the data having different features (or different classes) from one another are located distant from one another in the embedding space.

Through such embedding learning, the normal images (or the first embedded features corresponding to the normal images) are located proximal to one another in the embedding space and thus clustered.

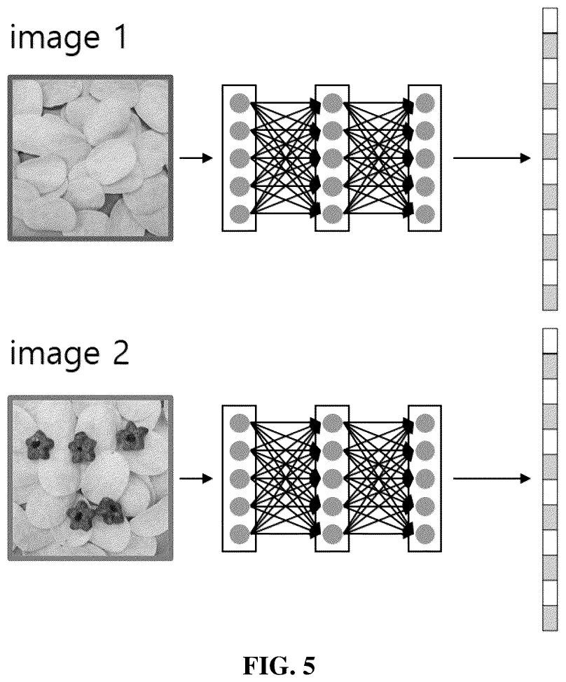

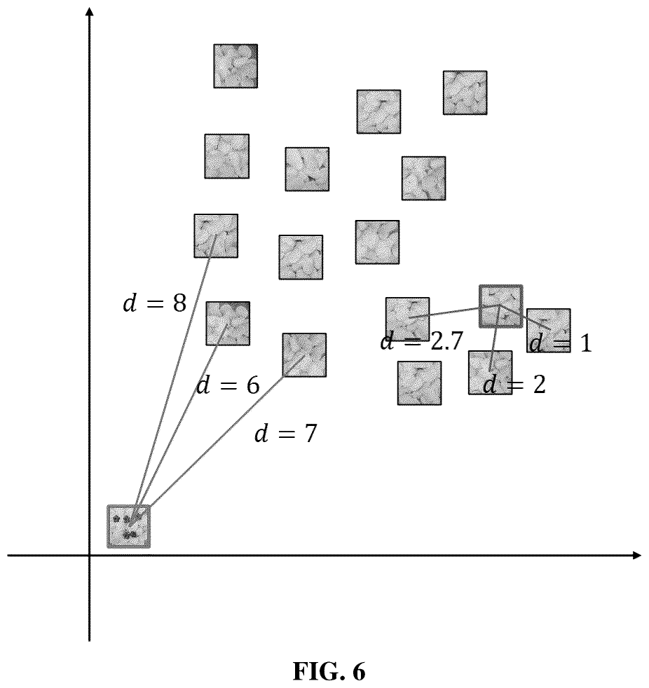

FIGS. 5 and 6 show exemplary processes of distinguishing normal data and abnormal data in the anomaly detection method according to the embodiment of the present disclosure.

Referring to FIGS. 5 and 6, first, if input data (for example, images that require a determination as to whether they are normal or not) are inputted to the network function subjected to the embedding learning with the learning data, the second embedded features corresponding to the input data are mapped onto given positions in the low-dimensional embedding space.

If the input data are normal images, the second embedded features are located proximal to the first embedded features of the normal images clustered in the embedding space by means of the learning of the network function, and contrarily, if the input data are abnormal images, the second embedded features are located distant from the first embedded features of the normal images. Accordingly, the anomaly scores of the input data are calculated, based on the distances (that is, the sum or average of the distances) between the second embedded features and the first embedded features proximal to the second embedded features in the embedding space.

For example, as shown in FIG. 6, it is assumed that the embedding space is two-dimensional space, and if the distances between the second embedded feature corresponding to the first input data and the three first embedded features proximal to the second embedded feature are 2.7, 2, and 1, the anomaly score of the first input data is 1.9 as the average value of the distances. Contrarily, if the distances between the second embedded feature corresponding to the second input data and the three first embedded features proximal to the second embedded feature are 8, 6, and 7, the anomaly score of the second input data is 6 as the average value of the distances.

In this case, if a threshold value of the anomaly score is 3, the anomaly detection device determines that the first input data is a normal image and the second input data is an abnormal image.

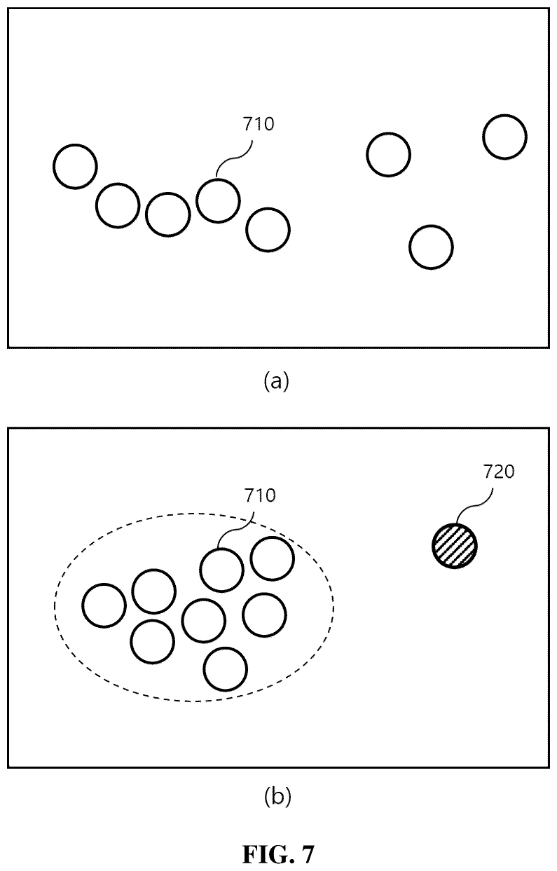

FIG. 7 shows the auxiliary data utilization effectiveness in the anomaly detection method according to the embodiment of the present disclosure.

In specific, FIG. 7a shows the distribution of the embedded features in the embedding space if the network function is subjected to the embedding learning only with the normal data, and FIG. 7b shows the distribution of the embedded features in the embedding space if the network function is subjected to the embedding learning with both of the normal data and the auxiliary data.

If the learning is performed only with the normal data, as shown in FIG. 7a, a degree of clustering of the normal data 710 mapped onto the embedded space becomes deteriorated, and contrarily, if the learning is performed with both of the normal data and the auxiliary data, as shown in FIG. 7b, a degree of clustering of the normal data 710 mapped onto the embedded space becomes good.

If the learning of the network function is performed with both of the normal data and the auxiliary data, that is, the distribution among the normal data becomes decreased, and the differential features for identifying the normal data 710 are more abundantly learned through the auxiliary data 720, thereby more improving the effectiveness in determining the abnormal data.

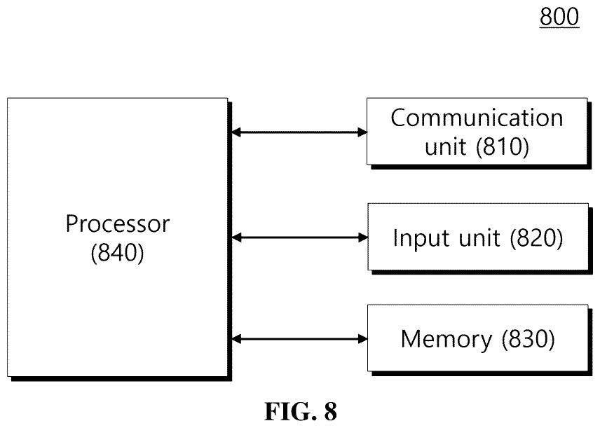

FIG. 8 is a schematic block diagram showing a configuration of an anomaly detection device according to another embodiment of the present disclosure.

A communication unit 810 receives input data so as to determine whether the input data are normal. The communication unit 810 includes wired and wireless communication units. If the communication unit 810 includes the wired communication unit, it may include one or more components for performing communication through a local area network (LAN), a wide area network (WAN), a value added network (VAN), a mobile radio communication network, a satellite communication network, and a combination thereof. If the communication unit 810 includes the wireless communication unit, further, it may transmit and receive data or signals wirelessly by using cellular communication, a wireless LAN (e.g., Wi-Fi), and the like. According to an embodiment of the present disclosure, the communication unit 810 transmits and receives data (for example, input data so as to determine whether the input data are normal) or signals to and from the external device or external server under the control of a processor 840.

An input unit 820 receives various user commands through external control. To do this, the input unit 820 includes one or more input devices or is connected to the input devices. For example, the input unit 820 is connected to an interface for various inputs, such as a keypad, a mouse, and the like and receives user commands from the interface. To do this, the input unit 820 includes an interface such as a USB port, a Thunderbolt interface, and the like. Further, the input unit 820 includes various input devices such as a touch screen, a button, and the like or is connected to the input devices to receive the user commands from the outside.

A memory 830 stores programs for operating the processor 840 and temporarily or permanently stores data inputted and outputted. The memory 830 includes at least one storage medium of a flash memory, a hard disc, a multimedia card micro storage medium, a card type memory (e.g., SD or XD memory), random access memory (RAM), a static RAM (SRAM), a read-only memory (ROM), an electrically erasable programmable ROM (EEPROM), a programmable ROM (PROM), a magnetic memory, a magnetic disc, and an optical disc.

Further, the memory 830 stores various network functions and algorithms, while storing various data, programs (with one or more instructions), applications, software, commands, and codes for operating and controlling the device 800.

The processor 840 controls all of operations of the device 800. The processor 840 executes one or more programs stored in the memory 830. The processor 840 represents a central processing unit (CPU), a graphics processing unit (GPU), or a dedicated processor through which the method according to the embodiment of the present disclosure is performed.

According to the embodiment of the present disclosure, the processor 840 serves to allow a network function to learn mapping of first embedded features corresponding to learning data onto an embedding space. In this case, the learning data include at least one or more normal data and/or auxiliary data.

According to the embodiment of the present disclosure, the processor 840 serves to allow input data to be inputted to the network function subjected to the embedding learning to thus map second embedded features corresponding to the input data onto the embedding space.

According to the embodiment of the present disclosure, the processor 840 serves to calculate anomaly scores based on the distances between the second embedded features and at least one or more first embedded features proximal to the second embedded features and thus determine whether the input data are normal, based on the calculated anomaly scores.

According to the embodiment of the present disclosure, the processor 840 serves to detect at least one or more first embedded features in order of proximity to the second embedded features in the embedded space and thus calculate the anomaly scores based on the sum or average of the distances between the second embedded features and the detected first embedded features.

According to the embodiment of the present disclosure, the processor 840 calculates the anomaly scores of the input data, based on a K-Nearest Neighbor (KNN) function.

The anomaly detection method according to the embodiment of the present disclosure may be implemented in the form of a program instruction that can be performed through various computers, and may be recorded in a computer readable recording medium. The computer readable medium may include a program command, a data file, a data structure, and the like independently or in combination. The program instruction recorded in the recording medium is specially designed and constructed for the present disclosure, but may be well known to and may be used by those skilled in the art of computer software. The computer readable recording medium may include a magnetic medium such as a hard disc, a floppy disc, and a magnetic tape, an optical recording medium such as a compact disc read only memory (CD-ROM) and a digital versatile disc (DVD), a magneto-optical medium such as a floptical disk, and a hardware device specifically configured to store and execute program instructions, such as a read only memory (ROM), a random access memory (RAM), and a flash memory. Further, the program command may include a machine language code generated by a compiler and a high-level language code executable by a computer through an interpreter and the like.

Further, the anomaly detection method according to the disclosed embodiments is included in a computer program product. The computer program product as a product may be traded between a seller and a buyer.

The computer program product may include an S/W program and a computer readable storage medium in which the S/W program is stored. For example, the computer program product may include an S/W program type product (e.g., downloadable app) electronically distributed through a manufacturing company of an electronic device or electronic market (e.g., Google play store, an app store, etc.). To do such electronic distribution, at least a portion of the S/W program may be stored in the storage medium or temporarily produced. In this case, the storage medium may be a storage medium of a server of the manufacturing company, a server of the electronic market, or a broadcast server for temporarily storing the S/W program.

The computer program product may include a storage medium of a server or a storage medium of a client device in a system composed of the server and the client device. If a third device (e.g., smartphone) connected to the server or client device exists, the computer program product may include a storage medium of the third device. Otherwise, the computer program product may include an S/W program itself transmitted from the server to the client device or the third device or from the third device to the client device.

In this case, one of the client device and the third device executes the computer program product to perform the method according to the disclosed embodiments of the present invention. Further, two or more devices of the server, the client device and the third device execute the computer program product to distributedly perform the method according to the disclosed embodiments of the present invention.

For example, the server (e.g., a cloud server or artificial intelligence server) executes the computer program product stored therein and controls the client device connected thereto to perform the method according to the embodiments of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An anomaly detection method comprising:
performing mapping learning of first embedded features corresponding to learning data onto an embedding space through a network function, wherein the learning data have at least one or more normal data;
mapping second embedded features corresponding to input data onto the embedding space by inputting the input data to the network function subjected to the learning;
calculating anomaly scores based on distances between the second embedded features and at least one or more first embedded features proximal to the second embedded features in the embedding space; and
determining whether the input data are normal, based on the calculated anomaly scores.

2. The anomaly detection method according to claim 1, wherein the learning data further comprise at least one or more auxiliary data, and the auxiliary data have classes which do not overlap with the normal data.

3. The anomaly detection method according to claim 1, wherein in the performing the mapping learning, the network function learns to:
map the first embedded features produced from the learning data having a same class as one another onto positions proximal to one another; and
map the first embedded features produced from the learning data having different classes from one another onto positions distant from one another.

4. The anomaly detection method according to claim 3, wherein in the performing the mapping learning, the network function performs the learning based on at least one or more loss functions selected from Triplet loss, Max margin, NT-Xent, and NT-Logistic.

5. The anomaly detection method according to claim 1, wherein the calculating the anomaly scores comprises:
detecting the at least one or more first embedded features in order of proximity to the second embedded features; and
calculating a sum or an average of the distances between the second embedded features and the detected first embedded features.

6. The anomaly detection method according to claim 5, wherein the calculating the anomaly scores calculates the anomaly scores based on a K-Nearest Neighbor (KNN) function.

7. An anomaly detection device comprising:
a memory for storing a program for anomaly detection; and
a processor for executing the program and configured to:
perform learning mapping of first embedded features corresponding to learning data onto an embedding space through a network function;
map second embedded features corresponding to input data onto the embedding space by inputting the input data to the network function subjected to the learning;
calculate anomaly scores based on distances between the second embedded features and at least one or more first embedded features proximal to the second embedded features in the embedding space; and
determine whether the input data are normal, based on the calculated anomaly scores,
wherein the learning data have at least one or more normal data.

8. The anomaly detection device according to claim 7, wherein the learning data further comprise at least one or more auxiliary data, and the auxiliary data have classes which do not overlap with the normal data.

9. The anomaly detection device according to claim 7, wherein the processor is further configured to:
map the first embedded features produced from the learning data having a same class as one another onto positions proximal to one another; and
map the first embedded features produced from the learning data having different classes from one another onto positions distant from one another.

10. The anomaly detection device according to claim 9, wherein in the performing the mapping learning, the network function performs the learning based on at least one or more loss functions selected from Triplet loss, Max margin, NT-Xent, and NT-Logistic.

11. The anomaly detection device according to claim 7, wherein the processor is further configured to:
detect the at least one or more first embedded features in order of proximity to the second embedded features; and
calculate the anomaly scores based on a sum or an average of the distances between the second embedded features and the detected first embedded features.

12. The anomaly detection device according to claim 11, wherein the processor is further configured to calculates the anomaly scores based on a K-Nearest Neighbor (KNN) function.

13. A computer program stored in a non-transitory recording medium to execute the method according to claim 1.
